(19) United States
(12) Patent Application Publication
(10) Pub. No.: US 2007/0243384 A1
(43) Pub. Date: Oct. 18, 2007

(54) Method of removing coatings from plastic articles

(75) Inventors: Mark W. Waldrop, Royal Oak, MI (US); Michael J. Killian, Ferndale, MI (US); Lawrence E. James, Grosse Ile, MI (US)

Correspondence Address: NIXON & VANDERHYE, PC, 901 NORTH GLEBE ROAD, 11TH FLOOR, ARLINGTON, VA, 22203, US

(73) Assignee: BASF Corporation, Mount Olive, NJ (US)

(21) Appl. No.: 11/809,000

(22) Filed: Jun. 14, 2007

Related U.S. Application Data
(62) Division of application No. 10/656,527, filed on Sep. 5, 2003.
(60) Provisional application No. 60/408,604, filed on Sep. 6, 2002.

(51) Int. Cl. B08B 3/08; B08B 7/02; B32B 27/00; C09D 9/04

(52) U.S. Cl. 428/407; 134/17; 134/27; 510/204; 510/212

(57) ABSTRACT

A method is provided for removing paint from plastic parts by treating the painted part with a solvent mixture. The solvent mixture used to remove the paint is a mixture of a high-boiling pyrrolidone or piperidone (lactam) solvent and an aqueous mineral acid, optionally with a surfactant added.

### CROSS REFERENCE TO RELATED APPLICATIONS

This application is a divisional of copending U.S. application Ser. No. 10/656,527 filed on Sep. 5, 2003, which in turn is based on and claims domestic priority benefits under 35 USC §119(e) from U.S. Provisional Application Ser. No. 60/408,604 filed on Sep. 5, 2002, the entire content of each prior filed application being expressly incorporated hereinto by reference.

This invention relates to a method of removing coatings from plastic articles and to the solvent mixture used to remove the coatings.

The use of plastics to replace steel parts to reduce vehicle weight and improve fuel economy in automobile exteriors and interiors has increased dramatically. Other advantages of plastics include the ability be molded into intricate shapes that allow designers to combine several parts into one. This substantially reduces assembly costs and gives designers more styling options and flexibility. Plastics also do not corrode in the presence of road salt, sea spray, or acid rain. In addition, thermoplastics are recyclable.

Plastic auto parts are painted for decorative and functional reasons. Although plastics can be colored by blending pigments in with the plastic resin prior to molding (so-called “molded-in color”), plastics are typically painted to match the color of other parts. Plastics are also painted to improve their resistance to ultraviolet light, scratches, acid rain, and chemicals (e.g., gasoline). Paint enhances the appearance and some of the properties of plastic parts but it complicates recycling of rejected or damaged parts. The paint must be removed from the part prior to repainting in order to prevent a defect from showing through a new paint film or, if an old or waste part is to be cut into small pieces and molded into a new part, the coating must be removed before the plastic is re-molded to prevent degradation of the physical properties (e.g., flexural modulus, impact resistance, surface appearance, or tensile strength) of the new part.

The problem of recycling reject parts is particularly critical to molders of new parts because plastics can be extremely difficult to paint. Plastics have lower surface energy than metals, so it is more difficult for coatings to wet plastic surfaces sufficiently to achieve good adhesion. Paint wetting can also be hindered by residual mold release left on the surface of the parts. It is common for molders of nylon or thermoplastic polyolefin (TPO) to have paint reject rates of 5-10% and higher. Currently, the automotive industry allows molders to repaint parts twice before the part is no longer considered a “new” part. This means that a part can be coated with up to three layers of paint. If a part is still rejected at that point, it is usually discarded. As a result, molders attempt to save reject parts in many ways.

One method used to save parts is to physically sand defects out of them by hand with sandpaper prior to repainting. This process can yield passable results on some parts but the sanding process is labor-intensive, expensive, time-consuming, and inexact.

Another method used to remove coatings from plastics is water blasting (Hosoyama, U.S. Pat. No. 5,475,036). In order to remove coatings, water blasting must be carried out at high pressures, on the order of 3,000-5,000 psi, and preferably at elevated temperatures-conditions which can be dangerous to operators. The angle of the water spray to the part surface must also be maintained to achieve good paint removal. This is difficult to manage on curved surfaces and small parts such as door handles.

Melt-filtering of paint residue from plastic resin in an extruder is also used to remove paint from plastics. This method has the disadvantages that parts must first be comminuted before they can be processed, and a very large surface area of fine filter media is required to remove paint particles sufficiently. Invariably, some paint residue is left behind that degrades the physical properties of the resin. The physical properties. of thermoplastics such as nylon are also adversely affected by the melting and extruding process itself (e.g., yellowing, decreases in tensile strength, etc.)

Various methods of chemically stripping paint from plastic parts have been proposed. For example, paint has been stripped from plastic bumpers made of PBT/PC blends by cutting them into pieces, wetting them with high pH caustic solutions, and mixing them (Lohr, et. al. U.S. Pat. No. 5,578,135). Paint is removed through a combination of hydrolysis of the coating by the caustic and abrasion caused by the particles rubbing against one another. This method has the disadvantages that parts must be comminuted before paint can be removed, and the resin can be hydrolyzed by the caustic. The resin must also be stabilized in an extruder after paint removal.

Paint has been removed from thermoplastic polyolefin (TPO) bumpers by comminuting the bumpers, mixing them in hot N-methyl pyrrolidone (NMP) solvent, rinsing them with water, and extruding the resin to remove residual solvent (Makato, et. al. JP 06031731). This method has the disadvantages that the parts must be comminuted prior to treatment with the solvent, and the TPO pieces must be passed through a devolatilizing extruder under vacuum to remove sufficient residual NMP in order to be molded into new parts. Furthermore, NMP by itself does not remove automotive coatings from plastics such as nylon 6 at all.

Paint can also theoretically be removed from plastics with volatile chlorinated solvents such as methylene chloride. However, in order to remove paint from nylon parts in a reasonable timeframe, methylene chloride must be heated. This is a problem because the breathing of methylene chloride vapor is harmful and tightly regulated with low worker exposure limits. This fact together with other environmental restrictions on the use of methylene chloride makes the solvent expensive and difficult to use in this application.

Paint and primer coatings have been removed from thermoplastic polyolefin substrates by treating a coated surface by dipping, brushing or another suitable technique with a composition comprising a carbonate, a pyrrolidone and a mono-ester, and optionally a ketone, optionally a glycol ether, optionally an alcohol, optionally an organic sulfur-containing compound and also optionally containing a thickener (Machac, US 2002/0198124A1).

Thus there is a need for a method of removing automotive coatings from plastic parts that does not require labor-intensive and imprecise hand-sanding or dangerous water blasting; that does not require comminuting the parts; that does not require that the plastic be subjected to extrusion and resulting decay in physical properties; and that does not expose the plastic substrate to harmful chemical mixtures that degrade its properties. Finally, there is a need for a method that removes coatings from multiple types of plastic substrates without damaging them.

This invention relates to a method for removing paint from plastic parts which comprises treating the painted part with a solvent mixture of a high-boiling aprotic polar organic solvent and a pH adjusting agent and to the solvent mixture used to remove the paint.

In one embodiment this invention the solvent mixture comprises a high-boiling aprotic polar organic solvent such as a pyrrolidone or piperidone (lactam), 1,3-dimethyl-2-imidazolidinone, dimethylsulfoxide, dimethylformamide, dimethylacetamide or a terpene liquid and an aqueous mineral acid.

In another embodiment of the invention, the solvent mixture comprises a high-boiling aprotic polar organic solvent such as a pyrrolidone or piperidone (lactam), 1,3-dimethyl-2-imidazolidinone, dimethylsulfoxide, dimethylformamide, dimethylacetamide or a terpene liquid and a tetraalkyl ammonium hydroxide.

In one embodiment of the invention, the painted part is placed in the solvent mixture and ultrasound is then applied.

In another embodiment the painted part is agitated in the solvent mixture.

The method of the invention allows for the complete removal of paint from multiple types of plastic parts without damage to the part.

Advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

The present invention may be understood more readily by reference to the following detailed description of exemplary embodiments of the invention and the examples included therein.

Before the present compositions and methods are disclosed and described, it is to be understood that the terminology used herein is for the purpose of describing particular embodiments only and is not intended to be limiting.

In one embodiment, this invention relates to a chemical mixture for removing automotive paint systems from full-sized reject or waste plastic parts, more particularly, from parts made of nylon.

The preferred plastic substrates are nylon 6, thermoplastic polyolefin (TPO), and styrenic polymers such as acrylonitrile-butadiene-styrene (ABS) although paint could be removed from any plastic that is insoluble in the solvent mixture (e.g., PBT). Preferably a terpene liquid solvent mixture is used for parts made of styrenic polymers. The paint systems removed are typical one-component (1K) or two-component (2K) paint systems consisting of polyester or acrylic primers, colored acrylic basecoats, and polyurethane-acrylic or polyurethane-carbamate clearcoats.

Examples of solvents used to make the solvent mixture used in the practice of the instant invention include pyrrolidone and substituted pyrrolidone solvents such as, for example N-methyl pyrrolidone, N-hydroxyethyl pyrrolidone, N-cyclohexyl pyrrolidone, and N-ethyl pyrrolidone. Piperidone solvents include 1,5-dimethyl piperidone, 1,3-dimethyl piperidone, and their mixtures. Other solvents include 1,3-dimethyl-2-imidazolidinone, dimethylsulfoxide, dimethylformamide and dimethylacetamide. Still other solvents are terpene liquids, either a substantially pure terpene liquid, a liquid mixture having two or more terpenes or either of the preceding in a liquid mixture containing additional compounds. It is also possible to use mixtures of these solvents. A preferred solvent is N-methyl pyrrolidone (NMP).

The terpene containing liquid comprises a liquid selected from the group consisting of hemiterpenes, monoterpenes, sesquiterpenes, limonene, cedar oil, pine oil, citrus oil, caraway oil, canola oil, spearmint, and combination of the preceding. In a preferred embodiment the terpene liquid comprises limonene.

In one embodiment of the invention, the solvent mixture comprises from about 50 to about 95 wt. % of the solvent, and from about 5 to about 50 wt. % of an inorganic acid solution, preferably from about 75 to about 95 wt % of the solvent and from about 5 to about 25 wt % of the inorganic acid solution.

The acid used to make the solvent mixture is generally a strong inorganic, or mineral, acid. Examples of acids include hydrochloric, sulfuric, and phosphoric acids. The preferred acid is hydrochloric acid. The hydrochloric acid can be of any concentration (e.g., 28, 31, 35, or 37% HCl); however, less concentrated solutions require longer soak times or higher temperatures to remove coatings efficiently. The preferred solution is 36-37% hydrochloric acid solution.

In another embodiment of the invention, the solvent mixture comprises from about 75 to about 98 wt. % of the solvent, and from about 2 to about 25 wt. % of a tetraalkyl ammonium hydroxide, preferably from about 85 to about 97 wt % of the solvent and from about 3 to about 15 wt % of the tetraalkyl ammonium hydroxide.

Paint may be removed from full-sized or comminuted parts. The preferred method is to immerse the parts or pieces in the solution at an elevated temperature of about 40-150° C., preferably about 70-90° C. It is also preferable that the parts or pieces are either physically agitated by mixing or stirring or are treated with ultrasound.

Ultrasonic energy can be applied at a frequency of about 20-30 kHz, preferably about 25 kHz. The ultrasonic energy is applied for a period of from about 5 minutes to about 3 hours, preferably from about 15 minutes to about 2 hours, more preferably from about 30 minutes to about 75 minutes.

The acid of the solvent mixture of the invention is an acid that dissolves nylon parts. The acid normally hydrolyzes the solvent of the solvent mixture. In addition, the solvent by itself-or in solvent blends-does not remove automotive paint from nylon. Surprisingly, however, the combination of the acid solution and solvent completely removes paint from the plastic parts without harming the plastic substrate. Parts can be repainted directly with no problems in paint adhesion or loss of strength in the part.

In another embodiment of the invention, a surfactant can be added to the solvent mixture to facilitate the drainage of the solvent mixture from the part after the paint is removed. Preferred surfactants of the invention include alcohol alkoxylate phosphate esters such as Klearfac AA-270 and non-linear alcohol alkoxylates such as Plurafac® RA40 or Plurafac® RA30.

The following are non-limiting sample procedures of the invention.

For full-sized parts, paint can be removed by:
a) Immersing the parts in hot (about 70-90° C.) solvent-acid mixture and applying ultrasonic energy at a frequency of about 25 kHz for about 30-40 minutes to completely remove the paint. The parts are withdrawn from the bath and residual free liquid is drained from them or is blown off of the parts with an air knife or similar apparatus.
b) Rinsing the parts with water one or more times to remove residual lactam—acid mixture. The parts may be rinsed by any physical means, e.g., immersing them, spraying them, immersing and lifting them repeatedly, or immersing them and applying ultrasonic energy.
c) Drying the parts to remove residual water. The parts may be dried by normal physical methods, e.g., hot forced-air drying, vacuum drying, air drying, etc.

For comminuted parts, paint is removed from the painted plastic chips by:
a) Immersing the painted plastic chips in hot (about 70-90° C.) solvent—acid mixture and mixing for from about 15 minutes to about 2 hours.
b) Separating the mixture to separate paint particles from the plastic substrate and the solvent mixture by means known in the art such as filtration, centrifugation, etc.
c) Rinsing the chips, first with NMP, then with water to remove residual lactam—acid mixture.
d) Drying the chips to remove residual water. The parts may be dried by normal physical methods know in the art such as fluid bed drying, vacuum drying, extruding in a devolatilizing extruder, etc.

The following are non-limiting examples of the invention.

### EXPERIMENTAL

### Example 1

### Removing Automotive Paint from Nylon 6 with NMP-HCl Blend at 70° C.

A mixture consisting of 90 wt. % NMP and 10 wt. % HCl acid solution was prepared by adding 900 g of NMP and 100 g of 36-38% Reagent Grade HCl solution to a glass jar and mixing. A 5-inch long door handle made of glass-filled nylon 6 and coated with a primer, acrylic basecoat, and polyurethane-acrylic clearcoat (1K) was placed in the jar. The jar was covered and placed in a 12 in.×18 in.×12 in. ultrasonic bath that was partially filled with water. The top ¼ of the jar remained above the surface of the water. The bath and the contents of the jar were heated to 70° C. and ultrasonic energy was applied at a frequency of 25 kHz. The paint was completely removed in 40 minutes. The part was then immersed in 25° C. water five times to remove residual NMP-acid solution. The part was allowed to air dry.

### Example-2

### Removing Automotive Paint from Nylon 6 with NMP-HCl Blend at 85° C.

A mixture consisting of 90 wt. % NMP and 10 wt. % HCl acid solution was prepared by adding 1658.7 g of NMP and 184.3 g of 36-38% Reagent grade HCl solution to a glass jar and mixing. A 6-inch long door handle made of glass-filled nylon and coated with a primer, dark silver acrylic basecoat, and polyurethane-acrylic clearcoat(1K) was placed in the jar. The jar was covered and placed in a 12 in.×18 in. ×12 in. ultrasonic bath that was partially filled with water. The top ¼ of the jar remained above the surface of the water. The bath and the contents of the jar were heated to 85° C. and ultrasonic energy was applied at a frequency of 25 kHz. The paint was completely removed in 30 minutes. The part was then immersed in 85° C. water for 15 minutes and in 25° C. water for an additional 15 minutes to remove residual NMP-acid solution. The part was allowed to air dry.

### Example 3

### Removing Automotive Paint from Nylon 6 with NMP-HCl Blend at 85° C.

A mixture consisting of 90 wt. % NMP and 10 wt. % HCl acid solution was prepared by adding 1658.7 g of NMP and 184.3 g of 36-38% Reagent grade HCl solution (Aldrich®) to a glass jar and mixing. A 6-inch long door handle made of glass-filled nylon 6 and coated with a primer, blue acrylic. basecoat, and polyurethane-acrylic clearcoat (1K) was placed in the jar. The jar was covered and placed in a 12 in.×18 in. ×12 in. ultrasonic bath that was partially filled with water. The top ¼ of the jar remained above the surface of the water. The bath and the contents of the jar were heated to 85° C. and ultrasonic energy was applied at a frequency of 25 kHz. The paint was completely removed in 15 minutes. The part was then immersed in 85° C. water for 15 minutes and in 25° C. water for an additional 15 minutes to remove residual NMP-acid solution. The part was allowed to air dry.

### Example 4

### Repainting and Testing Door Handles Stripped in NMP-HCl Blend

A total of nine 5 and 6-inch long door handles made of glass-filled nylon 6 and coated with a polyester primer, various colors of acrylic basecoat, and polyurethane-acrylic clearcoat (1K) were stripped as described in Example 2. The stripped handles were repainted with primer, a silver basecoat, and clearcoat. The handles were then checked for appearance and tested for initial paint adhesion, 240-hour water immersion, and handle strength. The appearance of all 9 handles was very good, and all nine handles passed the paint adhesion and handle strength tests.

### Example 5

### Removing Automotive from TPO Bumpers with NMP-HCl Blend at 85° C.

A mixture consisting of 90 wt. % NMP and 10 wt. % HCl acid solution was prepared by adding 1658.7 g of NMP and 184.3 g of 36-38% Reagent grade HCl solution to a glass jar and mixing. A ˜2.5-inch×˜4-inch curved piece weighing 38.11 g cut from a bumper made of TPO from and coated with ‘a primer, white basecoat, and polyurethane clearcoat (1K) was placed in the jar. The jar was covered and placed in a 12 in.×18 in.×12 in. ultrasonic bath that was partially filled with water. The top ¼ of the jar remained above the surface of the water. The bath and the contents of the jar were heated to 85° C. and ultrasonic energy was applied at a frequency of 25 kHz. The paint was completely removed in one piece in 35 minutes from the entire part surface, including curved sections and lettering. The part was then immersed in 70° C. water for 5 minutes and in 25° C. water for an additional 5 minutes to remove residual NMP-acid solution. The part was allowed to air dry. The final weight of the part was 35.15 g, a loss of 7.77% of its original weight, due to the loss of the coating.

### Example 6

### Removing Automotive from TPO Bumpers with NMP-HCl Blend at 70° C.

A mixture consisting of 90 wt. % NMP and 10 wt. % HCl acid solution was prepared by adding 1658.7 g of NMP and 184.3 g of 36-38% Reagent grade HCl solution to a glass jar and mixing. A ˜2.5-inch×˜4-inch flat piece weighing 22.15 g cut from a bumper made of TPO and coated with a primer, gray basecoat, and polyurethane clearcoat (1K) was placed in the jar. The jar was covered and placed in a 12 in.×18 in.×12 in. ultrasonic bath that was partially filled with water. The top ¼ of the jar remained above the surface of the water. The bath and the contents of the jar were heated to 70° C. and ultrasonic energy was applied at a frequency of 25 kHz. The paint was completely removed in one piece in 35 minutes from the entire part surface. The part was then immersed in 70° C. water for 5 minutes and in 25° C. water for an additional 5 minutes to remove residual NMP-acid solution. The part was allowed to air dry. The final weight of the part was 21.64 g, a loss of 2.30% of its original weight, due to the loss of the coating.

### Example 7

### Removing Automotive Paint from Shredded TPO Bumper

Approximately 300 ml of a 90 wt. % NMP and 10 wt. % Reagent Grade HCl acid solution (36-38% HCl) was prepared in-a 1-liter beaker. The 1-liter beaker was then placed on a hot plate and a Teflon-coated magnetic stir bar was added to it. Next, approximately 100 g of shredded TPO chips that had been coated with primer, multiple colors of basecoat, and polyurethane clearcoat were added to the beaker. The beaker was agitated at medium speed, and the NMP-HCl solution was heated to 85° C. The paint was completely removed from the TPO chips-in 2 hours. After the paint was removed, the TPO chips were separated from the NMP-HCl mixture with a strainer. The TPO chips were then rinsed by adding them to 500 ml of NMP in a separate 1-liter beaker and mixed for 15 minutes. The TPO chips were separated from the NMP with a strainer.

### Example 8

### Removing Automotive Paint from Parts Coated with Two-Component (2K) Polyurethane Clearcoat Finish

General Method: Reagent grade tetramethyl ammonium hydroxide (TMAH) (25% by weight solution in water) was added to NMP and the solution turned pink and a solid formed at the bottom of the test container. A few drops of Klearfac AA-270 surfactant were added. The part (5″ or 6″ Ultramid B3GM35 glass-filled nylon 6 door handle) had a polyester primer, acrylic basecoat and polyurethane-acrylic clearcoat (2K) finish. The part was completely submerged in the solvent mixture and the test containers were covered and placed in a 12′×8″ ultrasonic bath filled with water. All test were run at 85° C. with 25 kHz ultrasonics applied to the test solution. After rinsing, the part was allowed to air dry. The results are set forth in Table I.

TABLE I

| | Time | |
|---|---|---|
| Mixture | (min) | Paint Removal |
| 2365.2 g of NMP | 30 | All paint removed. |
| 262.8 g of TMAH | | |
| (10% by wt) | | |
| 1275.5 g of NMP | 31 | Almost complete removal. Only a tiny |
| 39.5 g of TMAH | | area of primer or adhesion promoter |
| (3% by wt) | | can be seen. |
| 731.5 g of NMP | 16 | All paint removed. |
| 38.5 g of TMAH | | |
| (5% by wt) | | |
| 693.0 g of NMP | 16 | All paint removed. |
| 77.0 g of TMAH | | |
| (10% by wt) | | |
| 731.5 g of NMP | 26 | Three parts were run separately at |
| 38.5 g of TMAH | | these-conditions with complete paint |
| (5% by wt) | | removal. |
| 731.5 g of NMP | 30 | Four parts were run separately at |
| 38.5 g of TMAH | | these conditions with complete paint |
| (5% by wt) | | removal. |
| 731.5 g of NMP | 30 | Three parts were run separately at |
| 38.5 g of TMAH | | these conditions with complete paint |
| (5% by wt) | | removal. |
| 1021.3 g of NMP | 45 | **This was done on a part coated with |
| 53.8 g of TMAH | | a one-component clearcoat. Only |
| (5% by wt) | | partial paint removal was observed. |

### Example 9

### Automotive Paint Removal using a Rotating Basket

Processing tanks were filled with 335 gallons (approximately 2,634 lb) of solvent mixture (90% NMP, 9% HCl, and 1% H₂SO₄). The tank was equipped with three 44″ long by 4″ diameter stainless steel 25 kHz ultrasonic transducers which were connected to ultrasonic generators capable of supplying 27 watts per gallon of ultrasonic energy. The rinse tank was filled with city water and set at a temperature of about 60° F. The stripping and rinse tanks were 440-gallon polypropylene tanks (55″L ×44′W×43″H). The processing tank was heated to 85° C. using an immersion heater.

The rotating barrel had a 65-gallon capacity and was made from titanium. The sides of the barrel were perforated and. it could be rotated at a rate of one revolution per minute. The rotating barrel was filled with 5″ and 6″ Ultramid B3GM35 glass-filled nylon 6 door handles with a polyester primer, acrylic basecoat, and polyurethane-acrylic clearcoat finish. The barrel was lowered into the tank and rotated for the entire test. The bath temperature was 83° C. The ultrasonic transducers were on but are not effective while the barrel was rotating. After 20 minutes, the barrel was lifted out of the stripping tank and rotated a few times to allow as much liquid as possible to drain back into the stripping tank. It was lowered into the rinse tank and allowed to rotate in the tank for 1 minute. Again, the majority of the parts were completely stripped. Only a few small door handles had some specks of paint in the grooves on the front side but these were easily wiped off by hand.

In the same set up described above, the rotating barrel was filled with 5″ and 6″ Ultramid B3GM35 glass-filled nylon 6 door handles with a polyester primer, acrylic basecoat, and polyurethane-acrylic clearcoat finish. The ultrasonic transducers were off. The barrel was lowered into the tank and rotated for 5 seconds every minute (equivalent to about ⅕ of a turn). After 20 minutes, the barrel was rotated for a little longer every minute. After 25 minutes, the barrel was lifted out of the stripping tank and rotated a few times to allow as much liquid as possible to drain back into the stripping tank. It was lowered into the rinse tank and allowed to rotate in the tank for 30 seconds. The majority of the parts were completely stripped. Only a few metallic silver parts and one white part were not completely stripped. A total of 123 handles were stripped during this test.

### Example 10

### Removal of Paint From Acrylonitrile-butadiene-styrene Plastic

In a glass container, 390.6 g of reagent grade d-limonene and 43.4 g of 36-38% reagent grade HCl solution were mixed using a stirring rod. A 3.5″×8″×0.125″ piece was cut from a full-sized ABS cowle vent grille coated with a typical coating system for this particular application. The test piece was completely submerged then the test container was covered and placed in a 12″×8″×12″ ultrasonic bath filled with water (˜4 oz of Plurafac RA-40 surfactant were added to the water to help the water degas during initial operation). The test was run at 85° C. with 25 kHz ultrasonics applied to the test solution. After testing the part was immersed in 25° C. water for 30 seconds to remove residual test solution. After rinsing, the part was allowed to air dry.

The above experiment was repeated with a 3″×2″×0.125″ piece of ABS/polycarbonate cut from a cowle vent grille coated with a typical coating system for this particular application. Again, the paint was removed in 40 minutes.

### Example 11

### Removing Automotive Paint from Nylon 6 with DMAC-HCl Blend

A mixture consisting of 90 wt. % DMAC and 10 wt. % HCl acid solution was prepared by adding 1658.7 g of DMAC and 184.3 g. of 36-38% reagent grade HCl solution to a glass jar and mixing. A 10-inch long door handle bezel made of Ultramid B3GM35 glass-filled nylon 6 and coated with a polyester primer, olive acrylic basecoat, and polyurethane-acrylic clearcoat (1K) was placed in the jar. The jar was covered and placed in a 12 in.×18 in.×12 in. ultrasonic bath that was partially filled with water. The top ¼ of the jar remained above the surface of the water. The bath and the contents of the jar were heated to 85° C. and ultrasonic energy was applied at a frequency of 25 kHz. The paint was completely removed in 28 minutes. The part was then immersed in 70° C. water for 2 minutes and 25° C. water for an additional 1 minute to remove residual DMAC-acid solution. The part was allowed to air dry. The dry weight of the part decreased by 1.8 g, a loss of 1.5% of its original weight, due to the loss of the coating.

### Example 12

### Removing Automotive Paint from Nylon 6 with DMF-HCl Blend

A mixture consisting of 90 wt. % DMF and 10 wt. % HCl acid solution was prepared by adding 1658.7 g of DMF and 184.3 g of 36-38% Reagent grade HCl solution to a glass jar and mixing. A 10-inch long door handle bezel made of Ultramid B3GM35 glass-filled nylon 6 and coated with a polyester primer, olive acrylic basecoat, and polyurethane-acrylic clearcoat was placed in the jar. The jar was covered and placed in a 12 in.×18 in.×12 in. ultrasonic bath that was partially filled with water. The top ¼ of the jar remained above the surface of the water. The bath and the contents of the jar were heated to 85° C. and ultrasonic energy was applied at a frequency of 25 kHz. The paint was completely removed in 26 minutes. The part was then immersed in 70° C. water for 1 minute and 25° C. water for an additional 1 minute to remove residual DMF-acid solution. The part was allowed to air dry. The dry weight of the part decreased by 2.4 g, a loss of 2% of its original weight, due to the loss of the coating.

1. A method for removing paint from a painted plastic part which comprises treating the painted plastic part at a temperature and for a time sufficient to remove the paint therefrom with a solvent mixture comprised of a high-boiling aprotic polar organic solvent and a pH adjuster, wherein the pH adjuster is a tetraalkyl ammonium hydroxide.

2-5. (canceled)

6. A method for removing paint from a painted plastic part which comprises treating the painted plastic part at a temperature and for a time sufficient to remove the paint therefrom with a solvent mixture of a high-boiling pyrrolidone or piperidone lactams solvent which is at least one selected from the group consisting of N-methyl pyrrolidone, N-hydroxyethyl pyrrolidone, N-cyclohexyl pyrrolidone, N-ethyl pyrrolidone, 1,5-dimethyl piperidone, 1,3-dimethyl piperidone, and 1,3-dimethyl-2- imidazolidinone and mixtures thereof, and a tetraalkyl ammonium hydroxide.

7. A method for removing paint from a painted plastic part which comprises treating the painted plastic part at a temperature and for a time sufficient to remove the paint therefrom with a solvent mixture of a tetraalkyl ammonium hydroxide and a solvent selected from the group of dimethylsulfoxide, dimethylacetamide, dimethylformamide and a terpene liquid.

8. The method of claim 1 wherein ultrasonic energy is applied to the combination of the painted part and the solvent mixture.

9. The method of claim 1 wherein the painted part is comminuted.

10. The method of claim 1 wherein the painted part is kept intact.

11. The method of claim 9 wherein the comminuted painted part is stirred in the solvent mixture.

12. The method of claim 1, wherein the solvent is selected from the group consisting of N-methyl pyrrolidone, N-hydroxyethyl pyrrolidone, N-cyclohexyl pyrrolidone, N-ethyl pyrrolidone, 1,5-dimethyl piperidone, 1,3-dimethyl piperidone, and 1,3-dimethyl-2-imidazolidinone and mixtures thereof.

13-24. (canceled)

25. A solvent mixture for removing paint from plastic which comprises a high-boiling aprotic polar organic solvent and a pH adjuster.

26. The solvent mixture of claim 25 wherein the high-boiling aprotic polar organic solvent is selected from the group consisting of N-methyl pyrrolidone, N-hydroxyethyl pyrrolidone, N-cyclohexyl pyrrolidone, N-ethyl pyrrolidone, 1,5-dimethyl piperidone, 1,3-dimethyl piperidone, 1,3-dimethylimidazolidinone, limonene, dimethylsulfoxide, dimethylformamide, and dimethylacetamide and mixtures thereof.

27. The solvent mixture of claim 26 wherein the solvent is N-methyl pyrrolidone.

28. The solvent mixture of claim 26 wherein the solvent is limonene.

29. The solvent mixture of claim 25 wherein the pH adjuster is an acid is selected from the group consisting of hydrochloric, sulfuric and phosphoric acid.

30. The solvent mixture of claim 29 wherein the acid is hydrochloric acid.

31. The solvent mixture of claim 30 wherein the acid is 36-37% hydrochloric acid.

32. The solvent mixture of claim 25 wherein the pH adjuster is a tetraalkyl ammonium hydroxide.

33. The solvent mixture of claim 32 wherein the tetraalkyl ammonium hydroxide is tetramethyl ammonium hydroxide.

34. The solvent mixture of claim 25 which also comprises a surfactant.

35. The solvent mixture of claim 34 wherein the surfactant is an alcohol alkyxylate phosphate ester or a non-linear alcohol alkoxylate.

36-37. (canceled)

38. Plastic parts that have been readied for paint application by immersion in a mixture of a high-boiling aprotic polar organic solvent and a pH adjuster to remove any prior paint system applied to the part.

39. Plastic parts that have been readied for paint application by immersion in a mixture of a high-boiling aprotic polar organic solvent, a surfactant and a pH adjuster to remove any prior paint system applied to the part.
